(19) United States
(12) Patent Application Publication
(10) Pub. No.: US 2008/0301582 A1
(43) Pub. Date: Dec. 4, 2008

(54) TASTE NETWORK WIDGET SYSTEM

(75) Inventor: Daniel GLUCK, New York, NY (US)

Correspondence Address: KENYON & KENYON LLP, 1500 K STREET N.W., SUITE 700, WASHINGTON, DC, 20005, US

(73) Assignee: TASTEINDEX.COM LLC, New York, NY (US)

(21) Appl. No.: 11/754,773

(22) Filed: May 29, 2007

(51) Int. Cl. G06F 3/048

(52) U.S. Cl. 715/811

(57) ABSTRACT

A system for generating a widget that can show the similarity between users. A web server can host a web page that is associated with an owner user. A similarity engine can determine the similarity of a visitor user from whom a request for the web page is received at the web server and the owner user. A widget generation module can create a widget that can include a graphical element that displays the similarity determined by the similarity engine between the visitor user and the owner user, as well as code that can be adapted to be executed by the visitor user computer. A widget transmission module can send the widget to the visitor user.

### RELATED APPLICATIONS

This application is related to U.S. application Ser. No. 11/754,701 “Taste Network System And Method,” filed on May 29, 2007 and to U.S. application Ser. No. 11/754,802, “Taste Network Content Targeting,” filed on May 29, 2007.

### FIELD OF THE INVENTION

The field of the invention is social networking, and in particular social networking via World Wide Web and related protocols.

### BRIEF DESCRIPTION OF THE DRAWINGS

FIG. 1 shows a taste focus slider tool in accordance with an embodiment of the present invention.

FIG. 2 shows a taste focus meter in accordance with an embodiment of the present invention.

FIG. 3 shows a taste focus area graph in accordance with an embodiment of the present invention.

FIG. 4 shows a taste focus network in accordance with an embodiment of the present invention.

FIG. 5 shows a search results display page in accordance with an embodiment of the present invention.

FIG. 6 shows a system for sending a graphic describing the taste difference between an owner of a personal web page and a visitor to that page to the visitor computer.

FIG. 7 shows a taste widget in accordance with an embodiment of the present invention.

FIG. 8 shows three taste networks in accordance with an embodiment of the present invention.

### DETAILED DESCRIPTION

In accordance with an embodiment of the present invention, content can be selected and shown to a given user based upon content that is known to appeal to other users with similar tastes. That is, on the basis of the similarity in taste between one user and other users. The content can be shown as the result of a search by the user. For example, the user may be known to like athletic fit clothing in bright colors. If the user searches for “Hugo Boss” and “shirt,” an embodiment of the system can identify which shirts were most highly rated by other users who also are known to prefer athletic fit, brightly colored clothing, and in particular such clothing made by Hugo Boss. The results can also include shirts and other clothing highly rated by users with similar tastes who also highly rated Hugo Boss clothing. In this way, content that has been rated by other users with similar tastes can enhance the relevancy of search results to a given user.

Information about a user's tastes can be gathered in many ways. For example, a user can complete a questionnaire, e.g., as part of a registration process. The questionnaire can ask for information relevant to assessing the user's tastes. It can include questions about the user's age, sex, income, geographic location, interests, etc. It can also include questions about the user's taste preferences. For example, it can ask for the user's preferences in food, clothing, color, home décor, etc. Questions about food can relate to preferred cuisines (e.g., American, French, Thai, etc.), preferred type of restaurant (e.g., formal, informal, expensive, inexpensive, etc.) and even specific preferred restaurants (e.g., Calloways, Night Time, Chez Boulanger, etc.) Dislikes can also be useful in determining a user's taste. The questionnaire can also ask the user to indicate strong dislikes. In one embodiment, the user can rate a given item on a sliding scale. For example, a version of a questionnaire can present a category “Restaurants” and permit the user to rate each of the following from −5 (strong dislike) to +5 (strongly like), with 0 representing no preference: American, French, Thai, Mexican, Expensive, Moderate, Inexpensive, Food Quality, Atmosphere, Service, Close to Home, etc. The responses submitted by the user can be used as a baseline for determining that user's closeness in taste to other users who took the same questionnaire.

Another way of collecting taste information is to have a user rate content. The content can be content randomly presented to the user, presented to the user as the results of a user-initiated search, etc. For example, a list of search results can be presented to the user ranked from highest to lowest estimated “closeness” to the user's taste. That is, each result can be ranked as having more or fewer attributes that are close to the user's taste than other results. The user can rank each result on a scale of −5 to +5. In this way, the system can “learn” more about the user's actual taste. For example, if a user consistently rates expensive Thai restaurants that are far from the user's home −5, then the system can learn that the user does not like expensive restaurants that are far away. Likewise, if a user consistently rates Thai restaurants highly regardless of the price, the system can learn that Thai cuisine is a favorite of the user.

Taste closeness can be measured in various ways. In one embodiment of the invention, taste closeness is measure by. Consider the following example of data:

TABLE 1

| | User 1 | User 2 | User 3 | User 4 | User 5 |
|---|---|---|---|---|---|
| Red | +5 | −1 | 0 | −3 | +4 |
| Yellow | +3 | +1 | +1 | −2 | +5 |
| Green | +1 | +4 | +1 | +2 | +2 |
| Black | 0 | +2 | +5 | +1 | +1 |

In accordance with an embodiment of the present invention, the numerical distance is calculated between each user to assess “closeness” in taste. That is,

Taste Difference_{i,j,k}=|Userᵢ−Userⱼ|

where Taste Difference_{i,j,k} is the magnitude of the taste difference between User i and User j with regard to k, Userᵢ is the rating of Userᵢ with regard to k and Userⱼ is the rating of Userⱼ with regard to k. The designation “k” can represent an attribute (e.g., a color, a style, a relative price, etc.), an item (e.g., a specific restaurant, a piece of content (such as a photograph, a web page, a search result) shown to the user, etc.

For example, with regard to User 1's preference for the color red, User 1 is 6 units away from User 2, 5 units from User 3, 8 units from User 4 and 1 unit from User 5. Thus,

| | User 1 | User 2 | User 3 | User 4 | User 5 |
|---|---|---|---|---|---|
| Taste Distance_{1,j,red} | 0 | 6 | 5 | 8 | 1 |

where “j” is indicated by the User number in the above table. As shown in the above table, User 1 is closest in taste with regard to the color red to User 5, and most distant in taste with regard to red to User 4. The other colors may be similarly rated to produce the following table:

| | User 1 | User 2 | User 3 | User 4 | User 5 |
|---|---|---|---|---|---|
| Taste Distance_{1,j,red} | 0 | 6 | 5 | 8 | 1 |
| Taste Distance_{1,j,yellow} | 0 | 2 | 2 | 5 | 2 |
| Taste Distance_{1,j,green} | 0 | 3 | 2 | 1 | 1 |
| Taste Distance_{1,j,black} | 0 | 2 | 5 | 1 | 1 |

Total distance across all of the colors can be computed by summing the differences and dividing by the number of colors to obtain an average distance:

| | User 1 | User 2 | User 3 | User 4 | User 5 |
|---|---|---|---|---|---|
| Taste Distance_{1,j,colors} = | 0 | 3.25 | 3.5 | 3.75 | 1.67 |

The above result indicates that User 5 is closer to User 1 in color taste than are Users 2, 3 and 4. This can be used to select content for color criteria. For example, when color is an attribute in selecting and organizing content for User 1, content that is highly rated by User 5 is more likely to be enjoyed by User 1 than content that is highly rated for color by Users 2, 3 and 4. Thus, if User 1 is searching for interior paint colors, colors for cars, etc., paint and car colors that are highly rated by User 5 may be shown to User 1 with a higher expectation that User 1 will like them than colors highly rated by Users 2, 3 and 4.

This approach can be used to recommend content in a multivariate scenario, i.e., with many different attributes. For example, the users may have rated how much various types of cars appeal to their tastes. The distance of each user's ratings to the ratings submitted by User 1 can be calculated, e.g.,

| | User 1 | User 2 | User 3 | User 4 | User 5 |
|---|---|---|---|---|---|
| Taste Distance_{1,j,sedan} | 0 | 8 | 5 | 6 | 3 |
| Taste Distance_{1,j,suv} | 0 | 3 | 2 | 4 | 0 |
| Taste Distance_{1,j,coupe} | 0 | 1 | 2 | 1 | 4 |
| Taste Distance_{1,j,sports} | 0 | 3 | 4 | 1 | 0 |

An average distance can be calculated for type of car in relation to User 1:

| | User 1 | User 2 | User 3 | User 4 | User 5 |
|---|---|---|---|---|---|
| Taste Distance_{1,j,car type} | 0 | 3.75 | 3.25 | 3.25 | 1.75 |

his shows that User 5 is closest to User 1 in taste for car type. Taste distance can be calculated in relation to User 1 for Color AND Car Type by summing both and dividing by the number of attributes, i.e., 2, to obtain an average distance.

| | User | User | User | | |
|---|---|---|---|---|---|
| | 1 | 2 | 3 | User 4 | User 5 |
| Taste Distance_{1,j,car type AND color} | 0 | 3.5 | 3.37 | 3.0 | 1.71 |

This indicates that User 5 is closest in taste to User 1 in both car color and car type. It is therefore likely that a car rated highly on color and type by User 5 would appeal favorably to User 1.

Additional criteria could be added to obtain more extensive estimates of taste difference. For instance, the cost of a car could be rated by the users. Taste distance in color, type and cost from a given user such as User 1 can be estimated in the same way. Such estimates can serve as the basis for decided whether or not to recommend content to User 1, or how to present such content to User 1. Content that has been highly ranked by other users with similar tastes can be presented to the user higher up on a list of search results than content that has not been so highly ranked, or than content that has been highly ranked by users who have substantially dissimilar tastes compared with User 1's.

Other schemes can be used to estimate taste distance. For example, rather than taking the absolute value of the taste distance between a user and other users, the square root of the sum of squares divided by two may be taken as the metric for such distance:

Taste Distance_{i,j,k}=½[(Userᵢ)²+(Userⱼ)²]^{1/2}

Likewise, the distance between User 1 and another user for more than one attribute may be calculated by multiplying (rather than adding, as above) the distances from User 1 for each attribute and dividing by two.

In one embodiment, taste distance is calculated with respect to mutual ratings for content that fall within a given set definition. For example, users may rate thousands of photographs, links, pieces of music, etc., pertaining to different subjects and circumstances. A set definition can be established to determine which rated content falls within the set. Examples of set definitions include “restaurants”, “Thai restaurants”, “work clothing”, “casual clothing”, “athletic shoes”, etc. Rated content that falls within a set definition can be compared for two users to determine their taste distance from each other. For example, out of the thousands of pieces of content rated, a first user may be found to have rated twelve restaurants in common. A taste distance between the two users may be calculated for the set definition “restaurants” using the techniques described above and other suitable techniques. In one embodiment, the absolute difference in rating between the two users may be calculated for each restaurant. The average of these differences can represent the taste distance between the two users with regard to restaurants. This taste distance can be used as described above to decide whether to recommend to the second user restaurants rated highly by the first user but unrated by the second user. If the calculated taste distance is small, then such recommendations should be made. If the taste distance is large, the two users have divergent taste in restaurants, and it would be less optimal to make such recommendations.

Weighting schemes can be used to reflect different levels of importance of various taste components. For example, it can be determined that a user is an amateur or professional expert in the field of automobiles. For example, the user may be determined to be a car salesman, own a collection of vintage cars, etc. Taste ratings by that user of content related to cars may be weighted accordingly.

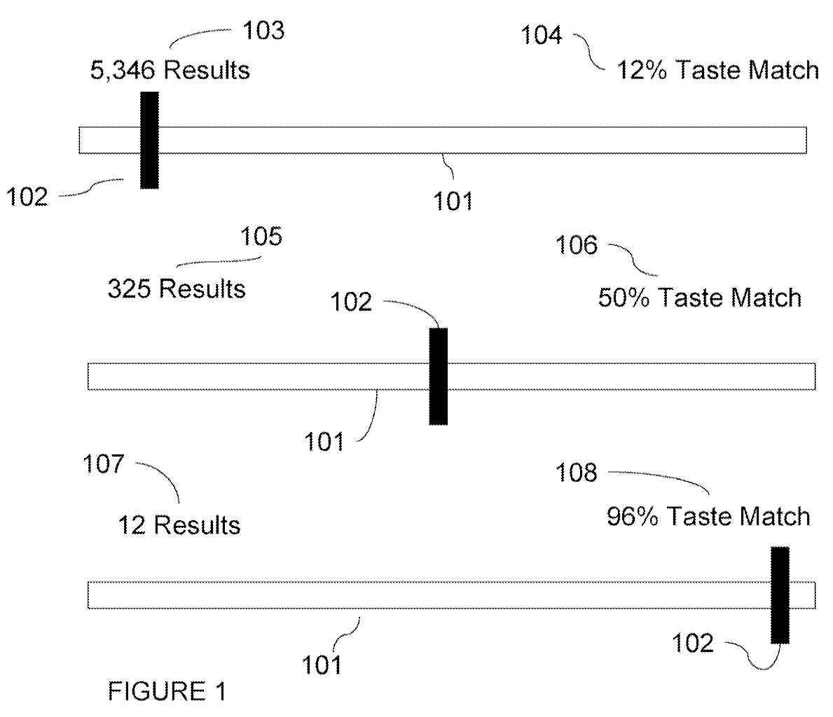

Taste distance calculations can be used to narrow the range of results returned in response to a search or reduce the size of a set of content for presentation to a user. A user may be provided with an interactive, online control that permits the user to specify such a broader or narrower range. An example of such a taste focus control is shown in FIG. 1. The slider bar of FIG. 1 is shown in 3 configurations. In the first example, the user has slid the sliding element 102 to the left end of the slider bar 101, permitting the user interface (not shown) to display search results or other content rated by other users who can have up to a large taste distance from the user. The number of results shown 103 is large. In the next example, the user has slid the sliding element 102 to the middle of the slider bar 101, further restricting the results shown to content recommended by users with a smaller taste difference from the user. The number of results 105 has correspondingly declined. Finally, the user has slid the sliding element 102 towards the right, indicating a desire to only see results that have been favorably rated by users with very similar taste to that of the user, i.e., of a small taste distance from the user. The number of results 107 is the smallest and most tightly focused. In this way, a user can expand or contract the number of results on the basis of taste closeness or further taste distance from the user, respectively.

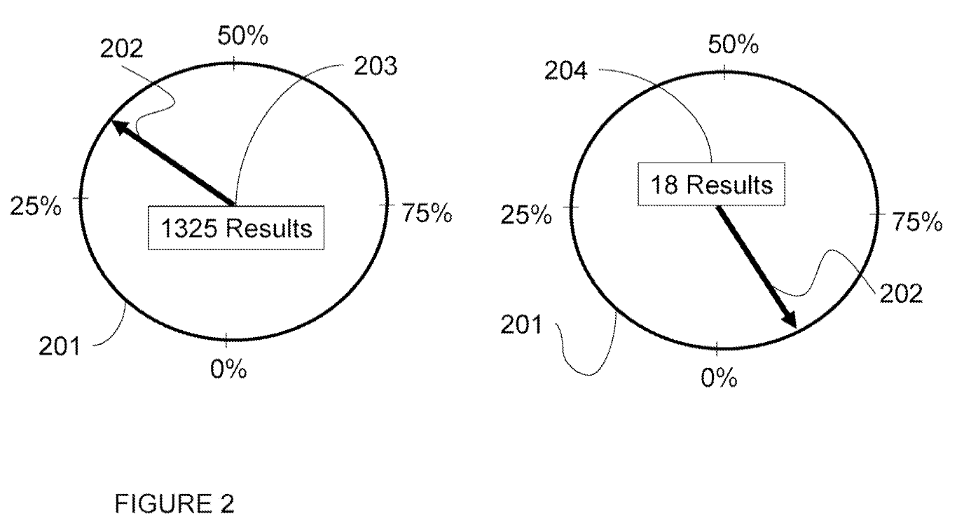

FIG. 2 shows another embodiment of the taste focus control. Here, the control is represented by a dial 201 having a movable arrow 202 that can be used to control how tightly focused the taste match should be. The number of results displayed is shown in 203. The second instance of the dial shows a tighter taste focus and correspondingly a fewer number of results are shown 204.

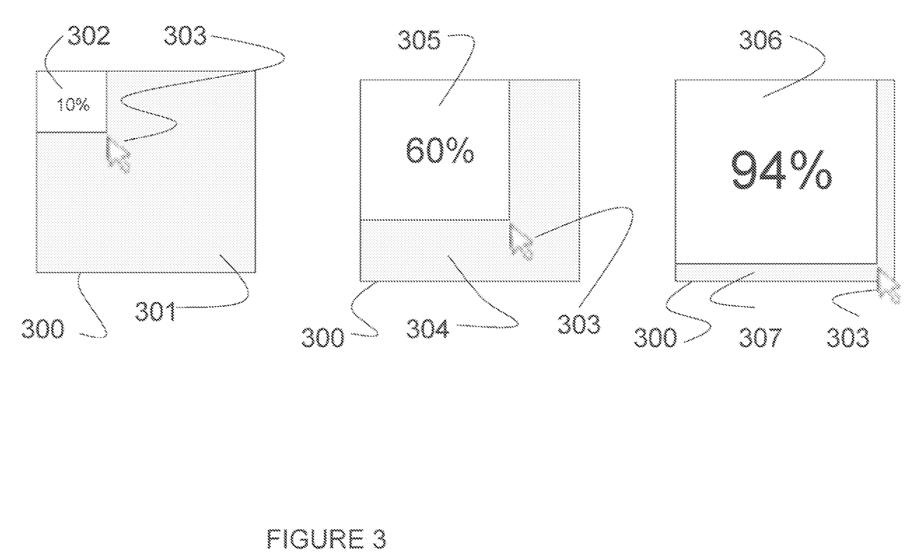

FIG. 3 shows an area-based taste focus control 300 whose entire area represents the whole taste universe. A smaller square 302, 305, 306 represents the percentage of the closest elements of the taste universe to be considered in returning results. The remaining area 301, 304, 307 represents the most distant elements of the taste universe, whose entries are not returned. The size of the small square 302, 305, 306 can be adjusted by the user utilizing arrow 303 to drag the corner of the small square 302, 305, 306.

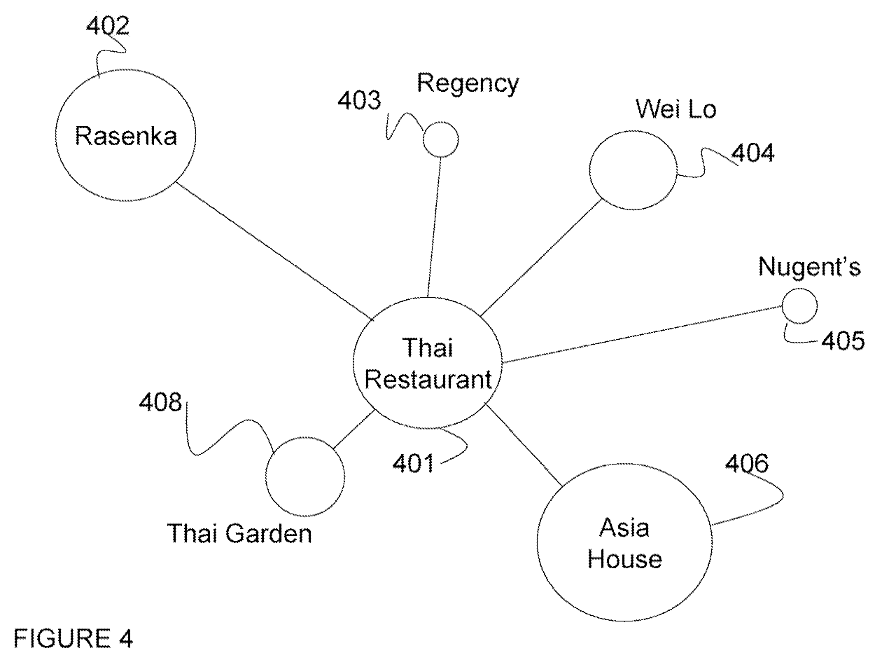

FIG. 4 shows yet another embodiment of a focus control. In this embodiment, the search term is shown in the center node 401. The results are shown as connected nodes 402-408. The size and proximity of each node to the central node 401 conveys information about the confidence of the recommendation and the taste difference of the item that corresponds to the node. The larger the node, the greater is the number of users who have rated the item favorably. The closer the node, the less the average taste distance between the searching user and the user who rated the item. Thus, a large node 406 close to the central node 401 indicates that many users with tastes similar to that of the searcher have rated that restaurant favorably. A small node 408 closer to the central node 401 indicates that fewer users rated that restaurant favorably, but the rating users are closer to the searcher in taste. A large node 402 remote from the central node 401 indicates that many users rated that restaurant favorably, but the average taste distance between the searcher and the rating users is substantial. Thus, the recommendation can be given less weight than the recommendation represented by, say, node 406.

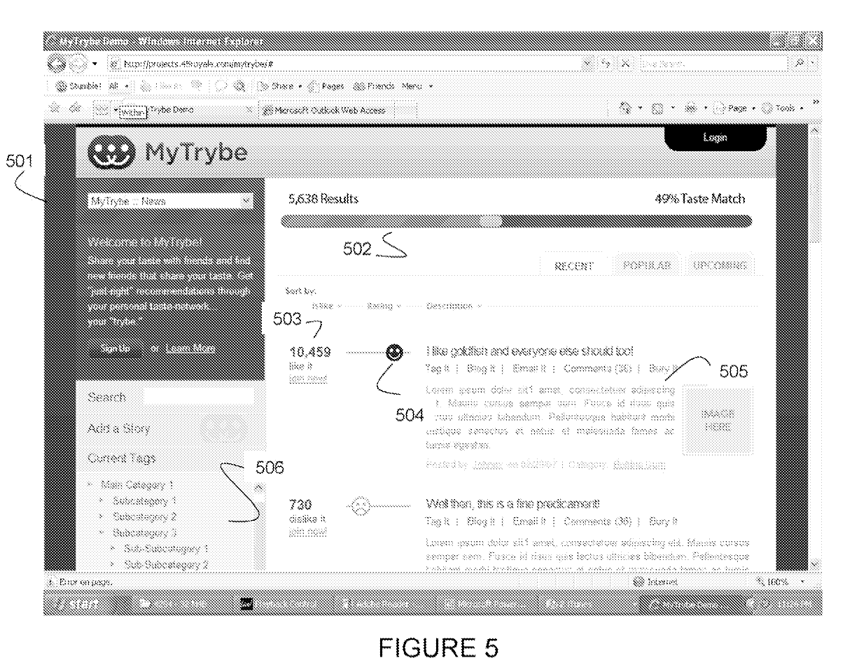

An embodiment of the interface 501 in accordance with the present invention is shown in FIG. 5. Taste focus control 502 permits users to specify the taste distance within which results are to be returned. It is presently set at a 49% taste match, meaning that only results rated by the 49% of users with closest taste to the searcher should be returned. Each result indicates the number of users 503 who rated the entry and can indicate the favorableness or unfavorableness of the overall rating, which can be represented textually and graphically 504. Each result includes information useful to the searcher 505 and can correspond to a category 506 that can be specified by the user.

The taste focus mechanism can improve the confidence of a user viewing his search results by providing an adjustable way to specify a similarity threshold outside of which no results are to be shown. The similarity threshold can be a number that is calculated based upon the viewing user's manipulation of the graphic mechanisms described above. For example, in the case of the slider bar shown in FIG. 1, the number can be expressed as a percentage. The percentage, say X %, signifies that only results that have been rated by the closest X % of other users in taste distance to the viewing user. That is to say, only those results rated by the X % most similar other users to the viewing users are to be displayed. Reducing the similarity threshold can exclude results that were rated by other users outside of the threshold. For example, when the slider bar is at 75%, search results rated by the closest 75% of users to the viewing user can be displayed. When the viewing user slides the bar from 75% to 25%, all search results rated by users from 75% to 25% closest to the search user can be eliminated from the display, providing a more focused result. In other words, the content can be removed in response to the viewing user changing the similarity threshold by sliding the bar on the taste focus mechanism or by making a change to any other taste focus mechanism. The viewing user may have more confidence in the more focused result because the viewing user can be more likely to agree with the ratings of other users who are closer (more similar) to the search user than those with less similar tastes. Reducing the similarity threshold too far may produce too narrow and few displayed results. In this case, the viewing user can also increase the similarity threshold and bring in additional results rated by users less similar to the viewing user.

A system in accordance with an embodiment of the present invention can include a taste focus device having a similarity threshold that is adjustable from a first value to a second value by the viewing user. A similarity engine can be used to determine the similarity of a user that has rated a given content with the viewing user. A difference module can determine if a given content item that is rated by a user within the second threshold value was not displayed to the viewing user at the first threshold value and if a content that is rated by a user outside of the second threshold value was displayed to the user at the first threshold value. This information can be used by a display management module to cause the appropriate content to be added or removed from a display, based upon the taste focus adjustment made by the user. For example, the display management module can cause to be added to the display content that the difference module determines is rated by a user within the second threshold value and was not displayed to the viewing user at the first threshold value. In other words, if the user lowers the threshold value (permitting content rated by other users less similar to the viewing user to be displayed), content that is within the new (second) threshold value but was not displayed at the first value can be caused to be added to the display. Conversely, the display management module can remove from the display content that is rated by a user outside of the second threshold value and that was displayed to the user at the first threshold value. That is, when the user raises the threshold value (restricting displayed content only to that content rated by users more similar to the viewing users), content that was within the old (first) threshold value and displayed but is not within the second threshold value is caused to be removed from the display.

Besides being adjusted by the user as described above, taste focus can also be set by the user during registration, when specifying his user profile or by making changes to his user settings at any time. Likewise, the system may set the user's taste focus settings based upon various factors, such as the user's experience with the system. A user with more experience may have a narrower taste focus (e.g., only display results based upon results from more similar users) than a user with less experience (e.g., display a wider range of results that include more distant users.) The system may automatically readjust the taste focus for a user over time, as the system learns more about the user's likes and dislikes. This can ensure that the most relevant results are presented to the user while lessening the chance that such results may get lost in a larger number of less relevant results.

Also, taste focus can be adjusted by providing the ability to sort results by similarity threshold. For example, each result can be associated with a given similarity threshold range, e.g., high, medium, low, 0%-50%, 70%+, under 30%, etc. Such range for each result or group of results can be indicated, for example, via an icon located proximate to the result or group. The user can be given the option of sorting by similarity threshold range. In this way, the user can control the display of results.

The present invention is not limited to search engines and the particular taste focus mechanisms described explicitly herein. Any content that is rated by other users can be selected for presentment to a viewing user based upon a similarity threshold specified by the viewing user. For instance, photographs in a large online gallery can be selected based upon a specified similarity threshold. The viewing user may want only to see such photographs that have been rated (across the gamut from unfavorably to favorably) by the 70% closest other users to the viewing user in taste distance. While the viewing user reduces the similarity threshold, photographs presently displayed to the viewing user can be removed from the display while the viewing user is making the change. Likewise, while the viewing user increases the similarity threshold, photographs not presently displayed but that fall within the new threshold can be added to the display while the viewing user is changing the threshold.

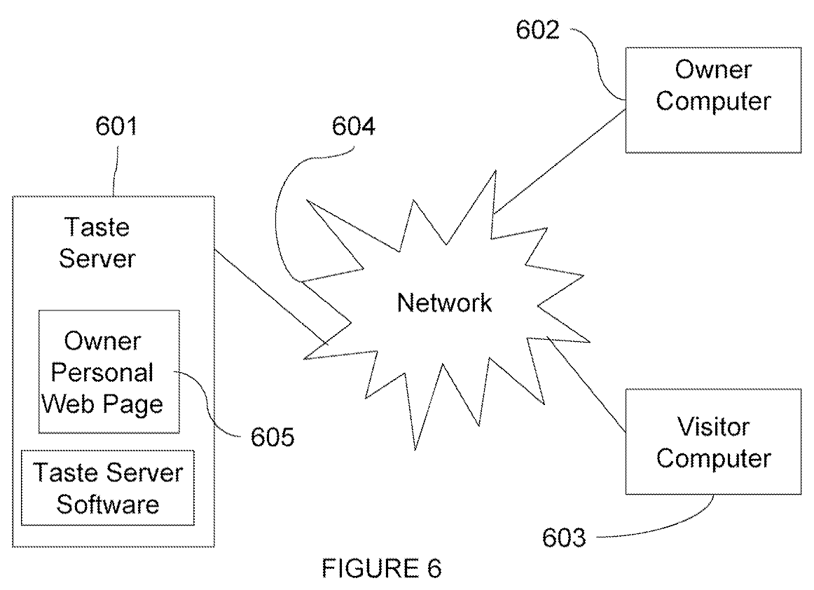

Taste difference can be communicated in a social networking context, such as on a dating site, a site such as MySpace (see www.myspace.com), etc. An embodiment of such a system is shown in FIG. 6. Taste server 601 is coupled to owner computer 602 and visitor computer 603 via network (such as the Internet) 604. Taste server hosts the owner's personal web page 605, e.g., as part of a dating web site or some other social networking site, such as MySpace. The personal web page has HTML or other software code that sends identity information of a visitor to taste server 601 when the visitor computer 603 sends a request to taste server 601 to send a copy of the owner's personal web page to a browser on the visitor computer 603. Identity information from the visitor is meant to encompass any information from which the visitor's identity can be derived. Upon receiving the visitor identity, taste server software 606 calculates the taste difference between the owner and the visitor and creates a graphic image (known as a “widget”) that includes the taste difference. Taste server 601 sends the graphic as part of the owner's personal web page to the visitor computer 603. In this way, the visitor can see the taste difference between himself or herself and the owner of the personal page.

A system for generating a similarity widget can include a web server that hosts a web page associated with an owner user and a similarity engine. The similarity engine can determine the similarity of a visitor user from whom a request for the web page is received at the web server and the owner user. For example, the similarity engine can determine that the visitor user is 58% similar to the owner of the web page that the visitor user is browsing. This can be done based upon the identity of the owner, the identity of the visitor (which can be read from a cookie on the visitor computer, provided by the visitor manually or automatically, etc.) and an analysis of the ratings of various content by the owner and visitor, e.g., along the lines described above or by using any other suitable technique. Here, “identity” is meant in a broad sense to include information that can personally identify a user, information that can associate the user with a type, category or class of users, or any other information that can suitably distinguish a user from at least one other user. A widget generation module can create a widget that includes a graphical element. The graphical element can display the similarity determined by the similarity engine between the visitor user and the owner user. The widget can also include code that can be executed by the visitor user computer to perform various functions. The widget can be sent to the visitor user by a widget transmission module.

An example of a mechanism for sending visitor identity information is to deposit a cookie on the visitor computer 603 when the visitor registers as a member of the social network. When taste server 601 receives a request for the owner's web page from the visitor computer 603, taste server 601 can send a request to visitor computer 603 to send cookie information containing visitor identity information back to taste server 601.

In another embodiment, the present invention can be used to improve the response rate and relevance of advertising. A premise of this embodiment of the present invention is that if a user has responded favorably to an advertisement (e.g., by clicking through, by rating it favorably, etc.), then other users who are close in taste distance are more likely than users of greater taste to also respond favorably to the ad. Thus, an ad known to be favored by one user can be sent to a second round of users selected on the basis of being close in taste distance (e.g., within a threshold) to the first user. Responses to the ad by this second round of users can be monitored, and the process repeated. That is, copies of the ad can be presented to a third round of users selected on the basis of being close in taste distance to those second round users who responded favorably to the ad. Subsequent rounds of users can also be selected by expanding or contracting the threshold that determines sufficient “closeness” to send an ad. For example, if a first user responds favorably to an ad, a second round of ads may be sent to the 15% closest users in taste distance to the first user. If responses to those users are largely favorable, then the threshold can be relaxed and the distribution widened. For example, the third round of ads can be sent to the 30% of closest users in taste difference to the first user who has not already received the ad. In this way, the breadth of appeal of an ad can be gauged.

Ads can be distributed in this way through the widget mechanism described above. The widget can include executable software, such as HTML, Java, etc. This code can send a request from the visitor computer 603 to an ad server (either directly or indirectly) for an advertisement. The request can include information about the taste difference between the owner and the visitor. Based upon this information, the ad server can select and ad from a plurality of available ads and send it to be displayed on the visitor computer 603, e.g., as part of the widget, independently of the widget, etc. The ad server can select the ad by determining which ads the owner responded to favorably and the taste distance between owner and visitor. If the taste difference is small, the ad server could serve such a favorable ad to the visitor, e.g., by displaying it inside the widget. If there is a wide taste difference, then the ad server may send an ad to which the owner responded unfavorably. The owner could be compensated for allowing ads to be sent along with his widget. For example, the owner could be paid a small sum for every N click throughs of ads sent via his widget, where N is an integer. Thus, for every 1000 click throughs, the owner could be paid one dollar. Or for every 1000 ads sent, the owner could be paid fifty cents. Any suitable scheme could be used to incentivize the owner to permit ads to be sent along with this widget.

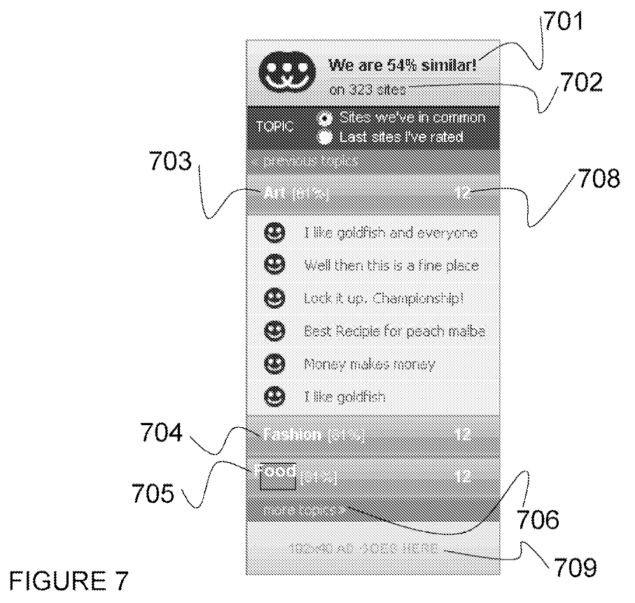

An example of a widget is shown in FIG. 7. A first part of the widget shows the taste similarity between an owner and a visitor, e.g., “We are 54% similar!” 701. Another part 702 shows the number of sites that both owner and visitor have rated and that can be used as the basis for computing the taste similarity, e.g., “on 323 sites.” The percentage of taste similarity can be calculated in accordance with the methods described above or any suitable method for indicating similarity. For instance, suppose four web sites or pages received the following ratings from the owner and visitor:

| | Owner | Visitor | Taste Distance |
|---|---|---|---|
| Site 1 | +5 | −1 | 6 |
| Site 2 | +3 | +1 | 2 |
| Site 3 | +1 | +4 | 3 |
| Site 4 | 0 | +2 | 2 |

A percentage similarity may be calculated on the basis of the taste distance, which in this example is the absolute value of the owner rating less the visitor rating, as described above. For example, the maximum of this form of taste distance on a [+5,−5] scale is 10. If the owner and visitor both rate the site the same, e.g., both rate it +3, then the taste distance is zero and owner and visitor are 100% similar with respect to that site. If the taste distance is 1, then the owner and visitor are 1/10 apart, i.e., are 10% different and thus are 90% similar. In other words,

Percent Similarity=100−Percentage Different, where

Percentage Different=100·(Taste Distance)/(Maximum Taste Distance)

Thus, for each of the sites above,

| | Owner | Visitor | Taste Distance | Percentage Similar |
|---|---|---|---|---|
| Site 1 | +5 | −1 | 6 | 40% |
| Site 2 | +3 | +1 | 2 | 80% |
| Site 3 | +1 | +4 | 3 | 70% |
| Site 4 | 0 | +2 | 2 | 80% |

A collective taste similarity can be computed with respect to the four sites above by averaging the percentage similarities. Thus, the owner and visitor could be said to be 67.5% similar. Collective similarity can be computed in any other suitable way. For example, the contribution of each site can be weighted and then the result can be normalized to reflect a greater similarity contribution from some site ratings than from others. Thus, for a maximum weight of 3 and a minimum weight of 0 for each rating, consider the following example:

| | Owner | Visitor | Taste Distance | Weight | Weighted Distance |
|---|---|---|---|---|---|
| Site 1 | +5 | −1 | 6 | 3 | 18 |
| Site 2 | +3 | +1 | 2 | 1 | 2 |
| Site 3 | +1 | +4 | 3 | 2 | 6 |
| Site 4 | 0 | +2 | 2 | 1 | 2 |

The collective percent similarity can be calculated as

$$100 - 100 \cdot \frac{{\sum }_{i = 1}^{i = 4} ( TasteDist ) i \cdot ( Weight ) i}{( MaxDist ) {\sum }_{i = 1}^{i = 4} ( Weight ) i}$$

where (TasteDist)i is the taste distance between the owner and the visitor for site i (e.g., 6 for site 1), (Weight)i is the weight for site i (e.g., 1 for site 1), MaxDist is the maximum distance possible between the owner and the visitor for each site (in the above example, 10). For the above example, the collective percent taste similarity is

$$100 - 100 \cdot \frac{18 + 2 + 6 + 2}{10 ( 3 + 1 + 2 + 1 )} = 60 \%$$

Thus, in the weighted example, the owner and the visitor can be considered to be collectively 60% similar across the 4 mutually-rated sites.

Taste similarity can be shown by category, e.g., for art 703, fashion 704, food 705, etc. The list of topic can be expanded or scrolled down 707 extensively. The number of sites used to calculate similarity (e.g., the number of commonly rated sites) can also be provided 708 to establish a confidence level in the similarity rating. For example, a visitor may have more confidence in a similarity rating that is based on a twelve commonly rated sites than on a single commonly rated site.

Another feature of the present invention can be confidence. Confidence ratings and confidence thresholds can help establish the reliability of a similarity rating in accordance with an embodiment of the present invention. For example, if a similarity rating is based upon how similarly two users have both rated a set of sites, the reliability of the similarity rating can be affected by the number of commonly rated sites that goes into the similarity rating. For example, two users who have rated 126 sites almost identically could have the same similarity (e.g., taste distance) as if the same two users rated 4 sites as similarly. But the confidence of the similarity rating for 126 sites can be greater than the rating based upon only 4 commonly rated sites.

A confidence rating can be shown on the widget. For example, the widget can show a similarity rating of 58% and indicate that this is “based on 110 sites in common.”Alternatively, a confidence index can be listed, such as a confidence rating from 1 (lowest confidence) to 5 (highest confidence). The thresholds for progressing from 1 to 5 can be set by the system, e.g., 1=less than five sites rated in common; 2=from five to fifteen sites in common; 3=from fifteen to twenty five sites in common; etc. Confidence can also be shown by changing the color of a similarity icon, e.g., red=low confidence; yellow=moderate confidence; green=high confidence.

The widget can also be used as a vehicle for carrying targeted advertisements, which can be shown in an area 709 of the widget. The ad can be a static image, a clickable image, an animation, a video, a sound rendering, etc. Control buttons can be provided (not shown) to stop, start and pause the video, to turn audio on and off, to scroll back to a previous ad, forward to a next ad, etc. As discussed above, the ad can be selected on the basis of the similarity between the visitor and other users who have shown a positive response to the ad.

In accordance with an embodiment of the present invention, all other users who are above a threshold similarity to a user are members of the user's “taste network.”Thus, all other users who are more than 80% similar to a given user can be members of the given user's 80%+ taste network. Likewise, a given user can have a narrower, more focused 90%+ taste network, a broader 70%+ taste network, etc. Taste networks can also be described negatively, e.g., in terms of dissimilarity. For example, other users who are no more than 40% similar to a given user can be in the given user's 40%− taste network.

As described above, one or more ads can be selected based upon positive response from other users in a given taste network of the user. For example, a set of available ads can be ranked by number of click-throughs by members of a user's similarity threshold taste network, e.g., the user's 80%+ taste network. The most clicked through ads by that network can be served to the user, e.g., through a widget. When the user is a visitor on an owner's site, an ad can be served on the widget once the widget is rendered to the user. Several ads can be sent to the widget while the user is a visitor and can view the widget. The response of the user to the ad can be tracked and this information can be used as the basis for targeting it and similar ads to other members of the user's taste network, and even for targeting future ads to the user himself. In another embodiment ads are rated, e.g., by an approve/disapprove button (not shown) on the widget in or near the ad area 709. Available ads can be ranked by the number of favorable responses by members of a given user's taste network and then the most favorably responded-to ads can be sent to the given user.

Ads can be selected based upon the favorable response of the other users who are members of the user's similarity threshold taste network. For example, ads that have a click-through rate greater than a click-through threshold (e.g., 2%, 5%, 7% etc.) can be selected to be sent to the user. In other words, for example, an ad that is clicked-through by at least 5% of the other users who are members of the user's 90%+ taste network can be selected to be sent and shown to the user. Other ads that fall short of the click-through threshold may not be selected, or be selected only if no ads that meet or exceed the click-through threshold.

Click-through rates are not the only metric for determining if members of a user's similarity threshold taste network respond favorably to an ad. Any suitable metric can be used. For example, percentage of rollovers, dwell time on the ad, ratings of the ad and other measures can be used. In general, such a metric can be a favorable response threshold. Examples of favorable response thresholds include a click-through rate of at least 5%, a rating of at least 4 out of 5 (5 being the most favorable), a dwell time on the ad of at least five seconds, etc.

A confidence threshold can be used in ad or other content targeting. For example, it can be used to weight the importance of favorable responses by other members of the user's similarity threshold taste network. The responses to the ad or other content by other users whose similarity to the user is of a low confidence can be weighted less than the responses of other users whose similarity is of a high confidence. In this way, an ad that has been favorably rated by taste network members with a low similarity confidence can be less likely to be shown to the user in some cases than an ad that has been favorably rated by a smaller number of taste network users with a high similarity confidence to the user. In certain embodiments, a confidence threshold can be used to discard or disregard responses and/or ratings by other users whose similarity to the user is less than a given confidence level. Thus, for example, responses and ratings from other users who have rated only two sites in common with the user can be disregarded for the purposes of similarity ratings, ad targeting, etc. Indeed, results can be filtered and sorted by confidence, just as with taste distance as described above.

An iterative process can be used to obtain more information about the appeal of an ad to various taste networks. For example, an ad that is successful with a user's 90%+ taste network may be sent to members of the user's 85%+ to 90%+ taste network. If the ad is successful in this range, the ad can be sent to members of the 80%+ to 90%+ range. In this way, the breadth of appeal of an ad can be measured.

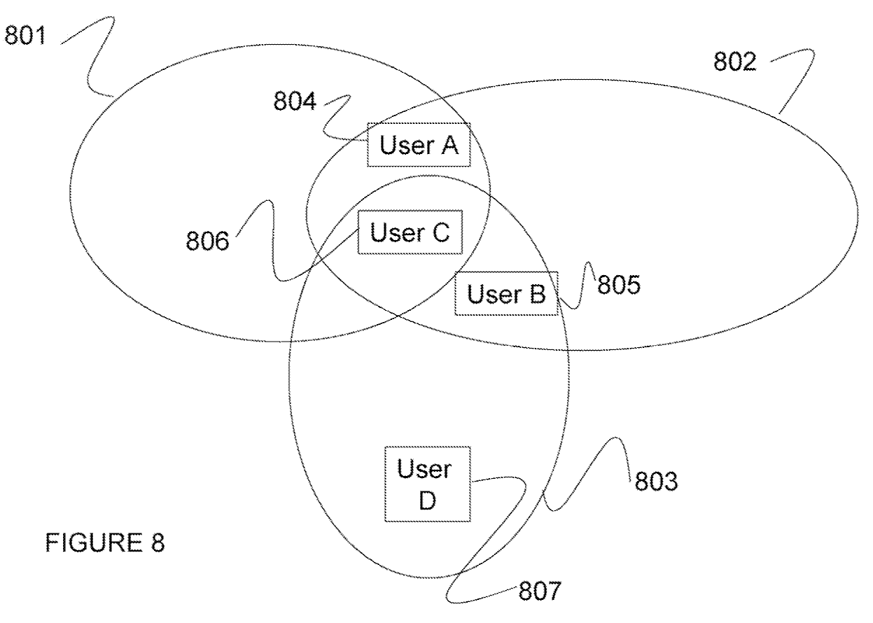

Ad targeting can be extended by linking taste networks. FIG. 8 shows three taste networks 801, 802 and 803. One taste network 801 is the group of other users who are at least 85% similar to user A 804, another 802 is the group of other users who are at least 90% similar to user B 805 and the other network 803 is the group of users who are at least 95% similar to user C 806. Taste networks 801 and 802 include some of the same members, such as user A 804. Taste networks 802 and 803 also include some of the same members, such as user B 805. User C 806 is a member of all three taste networks 801, 802 and 803. User D 807 is only a member of network 803. In accordance with an embodiment of the present invention, users who are members of more than one taste network can be used to propagate effective ad targeting across different groups of users who are more likely to respond positively to the ad. For example, an ad to which user A 804 responded favorably may be sent to the rest of the members of his taste network 801. If user C responds favorably to the ad, the system can then determine that user C is 95% similar to user D and target the ad to user D and that user C is 90% similar to user B and target the ad to user B. In a more general sense, an ad that is targeted to members of taste network 801 and that is favorably received by a member of taste networks 801, 802 and 803 can then be targeted to other users of taste networks 802 and 803. Likewise, and ad favorably received by user B 805, who is a member of networks 801 and 803, can then be targeted to other members of network 803. In this way, an ad can be propagated across taste networks by showing it to members of those networks, for example in an iterative process. Such members are more likely to react to the ad favorably than members of networks that are not so related. Members of more than one taste network can be termed “bridging members.”

In accordance with an embodiment of the present invention, minimum and maximum similarity thresholds can be set to determine which networks to next propagate an ad, e.g., ads can be propagated only across networks that contain members that are at least 90% similar to each other, that are less than 70% similar to each other, that are between 80% and 90% similar to each other, etc. Any suitable criteria can be established based upon any property of a taste network (size, diversity of membership, percentage similarity, etc.) Further, any suitable criteria can be established based upon any property of a bridging member, e.g., only bridging members who belong to 2 networks may be used to extend a targeting scheme from one network to another; only members who belong to between 2 and 4 networks may be used; only members who belong to at least 3 networks may be used; etc.

The iterative process may also take any suitable form. An ad to which a member responds favorably can first be deployed to his own taste network. A bridging member in that network can then be determined, and the ad can then be deployed to one or more other networks to which the bridging member also belongs. The confidence of a deployment to another network can be enhanced by gauging the response to the ad of one or more bridging members. If a threshold percentage or number of bridging members reacts favorably to an ad, then the ad may be deployed to one or more other networks to which the bridging member belongs. Otherwise, the ad may not be deployed to one or more of such other networks. For example, if at least 70% of members who belong to both networks 801 and 802 (such as user A) respond favorably to an ad deployed to members of network 801, then the ad can be deployed to network 802. If less than 70% of such members favorably respond, then the ad may not be deployed.

Ads selected as described above can be sent to the user via a widget or any other suitable delivery vehicle, e.g., as a banner ad on a web page, on or through a toolbar, etc. Ads may be expressed indirectly, as well. For example, content (e.g., such as videos on YouTube) may be accompanied with a button that is caused to change color based upon how favorably the video has been rated by members of the user's similarity threshold taste network. For example, a button next to a video on the YouTube site may be labeled “90%” to reflect the similarity threshold (users at least 90% similar to the visitor) and red for a low aggregate rating, yellow for a medium rating, and green for a high rating.

A system for similarity advertisement targeting can include a taste network engine that can identify the members of a similarity threshold taste network of a user. For example, the taste network engine can identify other users who are at least 90% similar to the user, i.e., are members of the user's 90%+ taste network. It can also include an advertisement selection module that can identify advertisements that have a favorable response equal to or greater than a favorable response threshold. For example, the advertisement selection module can identify ads that have been clicked through by at least 3% by other users who are members of the user's 90%+ taste network. An advertisement transmission module can cause a selected advertisement to be shown to the user, e.g., in a widget, as a banner ad, as another part of a web page, etc.

The ad targeting invention described above can be usefully extended to other kinds of content. For example, music can be selected for a user based upon how well it is liked by other users who are members of the user's similarity threshold taste network. For instance, music whose ratings by such other users exceed a rating threshold can be selected for the user. The user can be sent samples of such music, links to preview or buy such music, the actual music files themselves, etc. The same can be said for any kind of content, e.g., movies, videos, books, web sites, etc.

The foregoing description is meant to illustrate and not limit, the scope of the invention encompassed by the claims. Those of skill in the art will appreciate other embodiments from the description that will also be encompassed by the claims.

What is claimed is:

1. A method for delivering a similarity widget to a user visiting a web site, including:
receiving from a visitor user a request for a web page associated with an owner user;
determining the identity of the visitor user;
determining the similarity between the visitor user and the owner user;
creating a similarity widget that displays the similarity between the visitor user and the owner user;
sending the similarity widget to the visitor user.

2. The method of claim 1, wherein determining the identity of the visitor user includes reading a cookie on the visitor user computer and wherein the determined identity of the user is based upon information contained in the cookie.

3. The method of claim 1, wherein determining the identity of the visitor includes receiving a visitor identifier in the visitor user request for the web page.

4. The method of claim 1, wherein the similarity is expressed as a percent similarity.

5. The method of claim 1, further including causing the widget to be displayed along with at least part of the web page requested by the user.

6. The method of claim 1, wherein the widget includes an advertisement that can be displayed to the visitor user.

7. The method of claim 1, wherein the widget includes a link to a web server and further including sending content to the visitor user in response to the visitor user selecting the widget.

8. The method of claim 1, further including performing a function in response to the user selecting the widget.

9. A system for generating a similarity widget, including:
a web server that hosts a web page associated with an owner user;
a similarity engine adapted to determine the similarity of a visitor user from whom a request for the web page is received at the web server and the owner user;
a widget generation module adapted to create a widget that includes
a graphical element that displays the similarity determined by the similarity engine between the visitor user and the owner user; and
code adapted to be executed by the visitor user computer; and
a widget transmission module adapted to send the widget to the visitor user.

10. The system of claim 9, further including a visitor identity module adapted to determine the identity of the visiting user.

11. The method of claim 9, wherein the similarity engine is adapted to calculate a percent similarity between the visitor and the owner.

12. The method of claim 1, further including an advertising module adapted to select an advertisement to be included in the widget.
